(19) United States
(12) Patent Application Publication
(10) Pub. No.: US 2011/0286817 A1
(43) Pub. Date: Nov. 24, 2011

(54) METHOD AND APPARATUS FOR THE CONVEYANCE OF MATERIAL OUT OF A COMBUSTION BOILER

(75) Inventors: Rafael Moreno Rueda, Alpen (DE); Jeff Hudson, Doncaster (GB)

(73) Assignee: CLYDE BERGEMANN DRYCON GMBH, Wesel (DE)

(21) Appl. No.: 13/126,528

(22) PCT Filed: Oct. 24, 2009
(86) PCT No.: PCT/EP2009/064026

§ 371 Date: Aug. 9, 2011

(30) Foreign Application Priority Data
Oct. 31, 2008 (DE) 10 2008 054 098.6

(51) Int. Cl. F23J 1/06; F27D 3/00

(52) U.S. Cl. 414/216; 414/804

(57) ABSTRACT

A method and a device are involved in feeding hot material from a combustion boiler including at least one housing, at least one conveyor belt and at least one redirecting device, wherein the at least one conveyor belt first feeds the material with a first horizontal directional component and after passage through the redirecting device the material is fed with at least a second horizontal directional component that deviates from the first. Also, the material with the first directional component outside the redirecting device is continuously separated from the material with the second directional component. Additionally, the first directional component and the second directional component span an angle of 135° to 180°.

The present invention relates to an apparatus and a method for the conveyance of material out of a combustion boiler. The invention is employed, in particular, in plants having at least one combustion boiler, for example plants for the combustion of fossil fuels and/or waste incineration plants. Furthermore, the invention also relates to a corresponding plant with at least one combustion boiler and with an apparatus arranged beneath the combustion boiler.

The conveyance of material refers in this context to transporting away slag, ash or combustion residues which are designated hereafter as “material”. In this case, it is especially important, on the one hand, to achieve directed solidification or consolidation of the hot, sometimes still molten materials, so that, in particular, conveyance or further processing of these materials after they have been drawn off from the combustion boiler becomes possible. Furthermore, it is also desirable to utilize the energy still contained in the hot material and thereby improve the overall efficiency of the plant or combustion boiler.

Since it was initially assumed that quenching in a water bath is necessary for conveying the hot materials, this being designated as “wet discharge”, dry draw-off systems, as they are known, have also gained acceptance since the 90's. In this case, the hot material is laid onto conveyor belts and transported further on on these. At the same time, where appropriate, postcombustion or directed cooling of the hot material is carried out, this also taking place at least partially on the conveyor belt. The substances used in this case, in particular those of the conveyor belt, are therefore exposed to high temperatures, corrosive surroundings and/or high mechanical loads which they have to withstand. Moreover, the conveyor belts are constructed to be encapsulated in a housing with respect to the external surroundings. For this purpose, the conveyor belts have at least one housing which prevents the situation where combustion gases also arising during the conveyance of the material may readily emerge into the surroundings. Moreover, combustion boilers are operated under a slight vacuum, so that the combustion gases generated by the material are drawn off toward the combustion boiler by means of corresponding suction. Moreover, the combustion gases sucked into the boiler in this way are simultaneously preheated, so that, as well as undesirable combustion gases being diverted, the energy efficiency of the combustion boiler can thereby be improved.

A draw-off apparatus which is useful in terms of energy and is set up especially with regard to the cooling behavior may be gathered from EP 0 471 055 B1. It is made clear there that it is expedient to cool the hot material in two separate cooling stages, with an intermediate comminuting step for the hot material. In this case, in particular, a cooling air stream on the countercurrent principle is to be implemented, which is provided at the end of the second cooling stage and at the end of the first cooling stage. Special effects are explained there with regard to the comminution of the hot material and with regard to rearrangement of the layers, so that, overall effective operation of the combustion boiler is also to be made possible.

However, this construction has to take into account the fact that considerable construction space must regularly be available for its purpose. Moreover, it should not be forgotten that the provision of the comminuting stage between the two cooling stages necessitates an increased outlay in terms of equipment and, as regards the coupling of the systems, special requirements relating to the leaktightness of the systems even under high thermal and/or dynamic alternating stresses.

Proceeding from this, the object of the present invention is at least partially to solve the problems outlined with regard to the prior art. In particular, an apparatus and a method for the conveyance of material out of a combustion boiler are to be specified, which have an especially low construction space requirement, have an especially long service life and ensure reliable operation while at the same time having high energy efficiency.

These objects are achieved by means of an apparatus according to the features of claim 1 and a method according to patent claim 10. Further advantageous refinements of the invention are specified in the dependently formulated claims. It should be pointed out that the features listed individually in the dependently formulated patent claims may be combined with one another in any desired technologically expedient way and define further embodiments of the invention. Furthermore, the features specified in the patent claims are detailed and explained more particularly in the description, further preferred exemplary embodiments of the invention being illustrated.

In the present case, the objects are achieved by means of an apparatus for the conveyance of material out of a combustion boiler, which apparatus comprises at least one housing, at least one conveyor belt and at least one deflection device, the conveyor belt first conveying the material with a first horizontal direction component and, after running through the deflection device, conveying said material with at least one second horizontal direction component deviating therefrom, and, further, the material with the first direction component constantly being separated from the material with the second direction component outside the deflection device through the housing, and the first direction component and second direction component spanning an angle of 135° to 180°.

By the material first being transported away in an outward direction (first direction component) and thereafter in an at least approximately opposite return direction (second direction component), the length of the conveying path for the material in the housing can be prolonged, without the construction space requirement of the apparatus at the same time being increased considerably in the horizontal direction. In comparison with known apparatuses, with the conveying length being the same, the construction space requirement can even be reduced considerably. The term “direction component” is also intended to reflect the fact that here, where appropriate, (only) the projections of the actual conveying directions in the horizontal are considered and compared with one another, that is to say, where appropriate, the conveyor belts may still also have a vertical direction component (up and/or down). In this case, only the region “outside” the deflection device is usually considered, because here the material can, where appropriate, be conveyed without a horizontal direction component (that is to say, for example, only in the vertical direction).

The apparatus may (preferably) be set up basically such that a plurality of conveyor belts are used, for example in each case a conveyor belt per direction component. However, a type of endless conveyor belt may also transport the material at different heights lying vertically one above the other and with different horizontal direction components. These conveyor belts are then advantageously arranged vertically one above the other and have at least a partial overlap with one another in the vertical direction. In the case of a return of the material at an angle of 180°, the second direction component then, for example, corresponds exactly to the opposite first conveying direction. It is therefore preferable that the angle is near 180°, that is to say, for example, also greater than 165°. It is also clear that these angles relate here to only one direction of rotation, but this direction of rotation (right or left) can be selected freely, starting from the first direction component.

With regard to the angular range specified here, it should also be noted that a virtually complete direction reversal is as far as possible desirable, so that the conveyor belts require in the horizontal essentially a significantly smaller installation space than the sum of the individual installation spaces for each part conveying path or each conveyor. For this purpose, the conveyor belts overlap one another, that is to say are arranged, for example, in the manner of tiers (partially) one above the other, although this does not usually apply here (only) to the transfer region or the region of the deflection device.

Moreover, usually only one housing forming the entire conveying path is also provided. This also means, in other words, that all the conveyor belts are arranged so as to be encapsulated in a single housing, and this may, of course, also be assembled with a plurality of housing parts. In particular, the housing forms a separate housing chamber for each conveyor belt, so that, for example, each conveyor belt is surrounded by the housing. Accordingly, the housing may, for example, have a meander-shaped configuration, a conveyor belt being located in the horizontal portions and a deflection device being located in the lateral connecting portions.

Advantageously, the at least one conveyor belt is arranged in an overlapping manner in a central region of a direction component. Most especially preferred, therefore, is an apparatus for the conveyance of material out of a combustion boiler, in which apparatus a single housing, at least two conveyor belts and at least one deflection device are provided, the first conveyor belt initially conveying the material with a first horizontal direction component and, after running through the deflection device, the second conveyor belt conveying the material with at least one second horizontal direction component deviating therefrom, and the conveyor belts in this case overlapping one another in their central regions. The “central region” means, in particular, a part region of the conveyor belt which covers the central part region of the conveyor belt, that is to say there is (also) precisely here an overlap of the conveyor belts. In this case, for example, the conveyor belts may be arranged so as to cross one over the other, a transfer of the material onto the next conveyor belt taking place at the ends, for example, by means of chutes. Preferably, the first direction component and the second direction component likewise span an angle of 135° to 180° here.

In a further advantageous refinement of the invention, there is provision whereby, a third conveyance takes place in a vertical direction at least between the first conveyance with the first horizontal direction component and the second conveyance with the second horizontal direction component. The third conveyance in this case preferably takes place essentially in a vertical direction, for example through funnel-shaped guides or, in the simplest instance, in vertical free fall. By means of the third conveyance, for example, a belt change from a first conveyor belt to a second conveyor belt can taken place. The term “conveyance” is used particularly for part of the conveying path for the material in the housing.

It is likewise advantageous if the apparatus is surrounded by housing which comprises inlet and outlet orifices, provided at least in a directed manner, for the cooling air and which otherwise has the leaktightness required for the guidance of air masses. In this case, fresh air can be sucked into the housing in a directed manner via the inlet orifice and be discharged in a directed manner at an outlet orifice, for example, to a combustion boiler connected thereto. For this purpose, for example, the vacuum prevailing in the combustion boiler can be utilized. The remaining housing should be of essentially airtight construction, so that no undesirable secondary air is sucked into the housing. This ensures that the air quantities sucked in at the inlet orifice brush over the conveyed material along an entire conveying path length, thus ensuring complete post combustion and especially good preheating of the air quantities flowing to the combustion boiler. Inlet orifices for the air may be provided, for example, near an end portion of a conveyor belt and/or beneath a conveyor belt, for example the inlet orifices provided beneath the conveyor belt also being capable, where appropriate, of being lead to a separate cooling system for the drive elements of the conveyor belt (chain, rollers, etc.).

In another advantageous development of the invention, at least one additional cooling device is provided on the apparatus. This cooling device may, in particular, feed air or water for cooling into the housing. Advantageously, for this purpose, there is provision whereby the cooling device comprises at least one cooling air inlet for the controlled feed of cooling air. However, instead of the cooling air inlets or in combination with these, spray nozzles for the controlled feed of water as cooling medium may also be used. If required, the material to be conveyed can thus be cooled by air or water, for example in order to avoid damage to the conveyor belts, deflection device and/or adjoining conveying devices on account of excessively high temperatures. Furthermore, the flow direction of the entering cooling air can be controlled via the cooling air inlets, so that this cooling air is conducted in a controlled way to the locations heated to an especially great extent.

For continuous operation, it is advantageous, furthermore, if a comminuting device is provided in the apparatus along the conveying path. This comminuting device may preferably be arranged at or in a deflection device and provide for comminuting over large pieces of material. For this purpose, for example, contradirectionally operating crusher rollers may be employed.

Another advantage can be achieved in that the deflection device of the apparatus is constructed for varying a conveying path length. The conveying path length is in this case the total path length which material covers from the outlet orifice located at the combustion boiler as far as the opposite inlet orifice in the housing. When a plurality of conveyor belts are used, this conveying path length can be varied if the deflection device is constructed such that, for example, it transfers the material from a first conveyor belt directly to a third conveyor belt provided, at the same time bypassing a second conveyor belt. By means of such a deflection device, the material can selectively run through all three conveyor belts or alternatively, for example, only through the first and the third conveyor belt. If the material has, for example, especially high temperatures, it is expedient to prolong the conveying path length and carry out further cooling of the material. Conversely, in the case of low load or if the material is not so hot, the conveying path length can be reduced and one or more conveyor belts put out of operation, with the result that the service life of the conveyor belts is increased and the maintenance costs are lowered.

In another advantageous embodiment of the invention, a plant with at least one combustion boiler and with an apparatus which is arranged beneath the combustion boiler and comprises at least one conveyor belt and at least one deflection device is proposed, the apparatus being constructed in the abovementioned way according to the invention. In such an embodiment, the housing is connected, for example, to the bottom orifices of the combustion boiler, so that the hot material can be delivered from there onto the first conveyor belt, while flaps and/or grids may be arranged between them in order to achieve directed delivery according to size and/or quantity. Consequently, in particular, a cooling airflow through the housing can also be implemented with the aid of a combustion boiler operating under a vacuum. According to the abovementioned embodiment of the apparatus, for example, a plurality of conveyor belts or a meander-shaped conveying path can consequently be formed beneath the combustion boiler or beneath the bottom orifices of the combustion boiler, so that a long cooling section is implemented in an especially small construction space.

In an advantageous development of the plant, at least one measuring device is provided on the housing or therein. What may be considered as a measuring device is, for example, at least one sensor for determining at least one of the following parameters inside the housing: temperature, moisture, carbon monoxide, carbon dioxide, oxygen, heat radiation or density of the conveyed material. In this case, a plurality of (different) sensors may be arranged along the conveying path length. Thus, for example, even with a single temperature measuring device, for example at the inlet orifice or at the outlet orifice, a measurement value for determining the required conveying path length can be detected.

It is in this case most especially advantageous if the plant is constructed such that a control device is provided, which is connected by control technology at least to the measuring device or to the deflection device. If appropriate, the control device may also act on both devices. In this case, the control device, for example on account of appropriate programming, can execute control measures on the plant on the basis of the input variable supplied by the measuring device. Such a control measure may constitute, for example, the activation or orientation of the deflection device.

The method according to the invention for transporting material away from a combustion boiler, at which method the invention is also aimed, comprises at least the following steps:

a) generation of hot material by the combustion of a fuel in the combustion boiler;
b) conveyance of the material with a first horizontal direction component by means of a conveyor belt;
c) at least once-only deflection of the material by means of a deflection device;
d) conveyance of the material with a second horizontal direction component by means of a conveyor belt, the material according to step b) being kept separate from the material according to step d), and the horizontal direction components being selected such that they span an angle of 135° to 180°.

The method can also be implemented, in particular, by means of the apparatus or the plant according to the invention described, and therefore reference is also additionally made here to the corresponding explanations.

What are meant thereby are, in particular, the horizontal direction components directly following one another. These are, for example, the direction components of two successive conveyor belts, although, here, the essentially vertical conveyance in the deflection device from one belt to a further belt may be ignored.

By means of this method according to the invention, especially compact plants requiring an extremely small construction space can be operated.

Finally, in a development of the method according to the invention, there is provision whereby the number of deflections by means of the deflection device is determined and executed as a function of at least one measured variable. The measured variable in this case constitutes, in particular, a parameter of the material to be conveyed and/or of the surrounding in the housing, such as, for example, temperature, moisture, carbon monoxide, carbon dioxide, oxygen, heat radiation and/or density of the material conveyed.

The invention and its technical background are explained in more detail below by means of the figures. It should be pointed out that the figures show especially preferred construction variants of the invention which, however, is not restricted to these. In the diagrammatic drawing is shown:

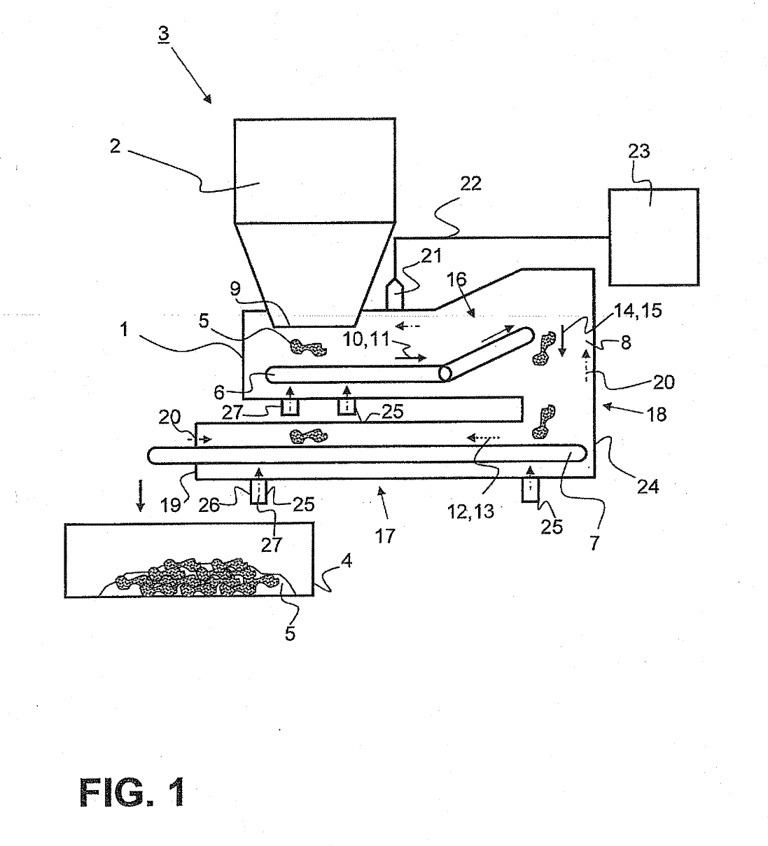

FIG. 1 a side view of a first plant according to the invention;

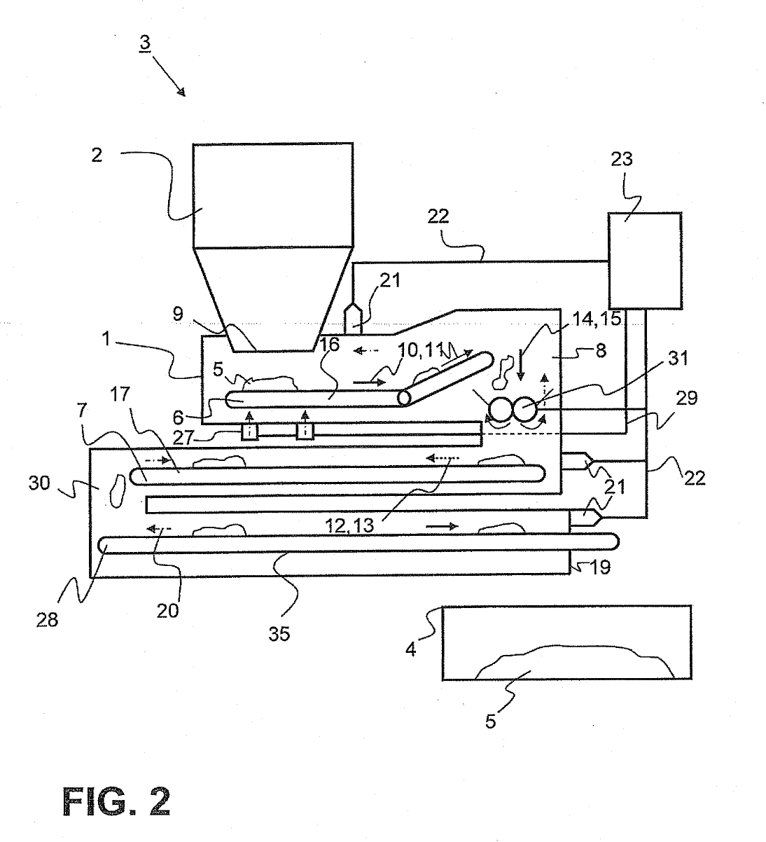

FIG. 2 a side view of a second plant according to the invention;

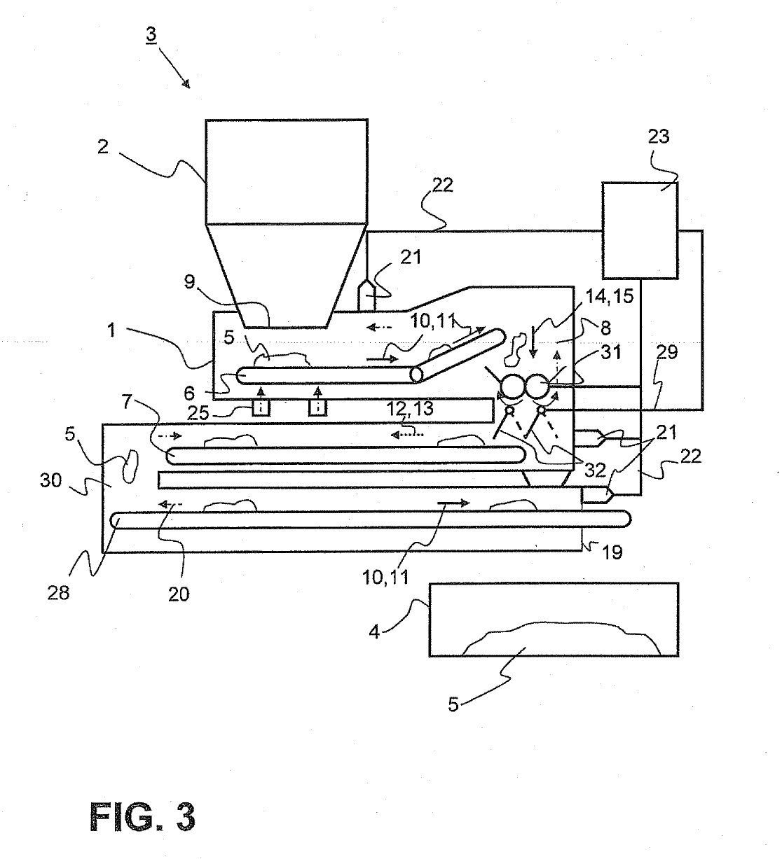

FIG. 3 a side view of a third plant according to the invention;

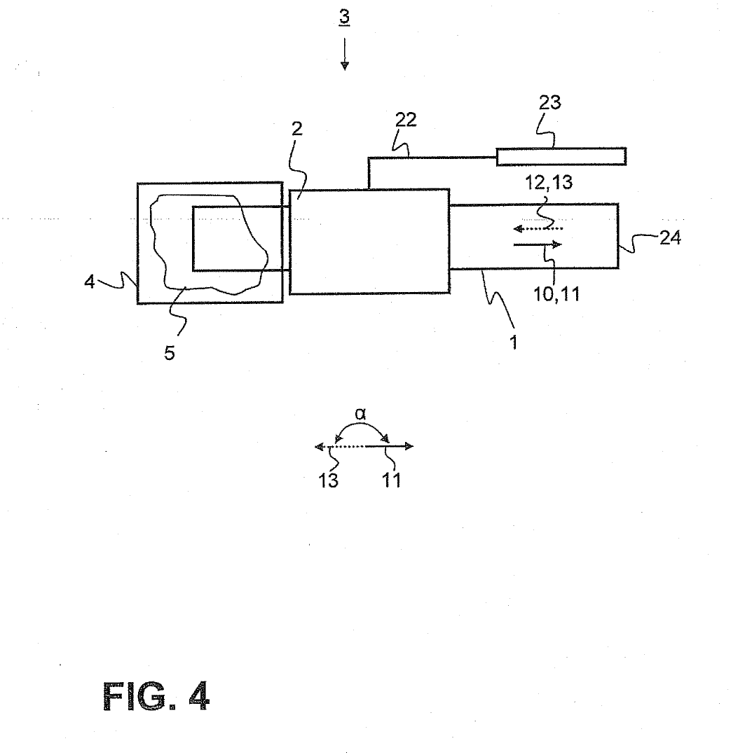

FIG. 4 a top view of the plant according to the invention, as shown in FIG. 1; and

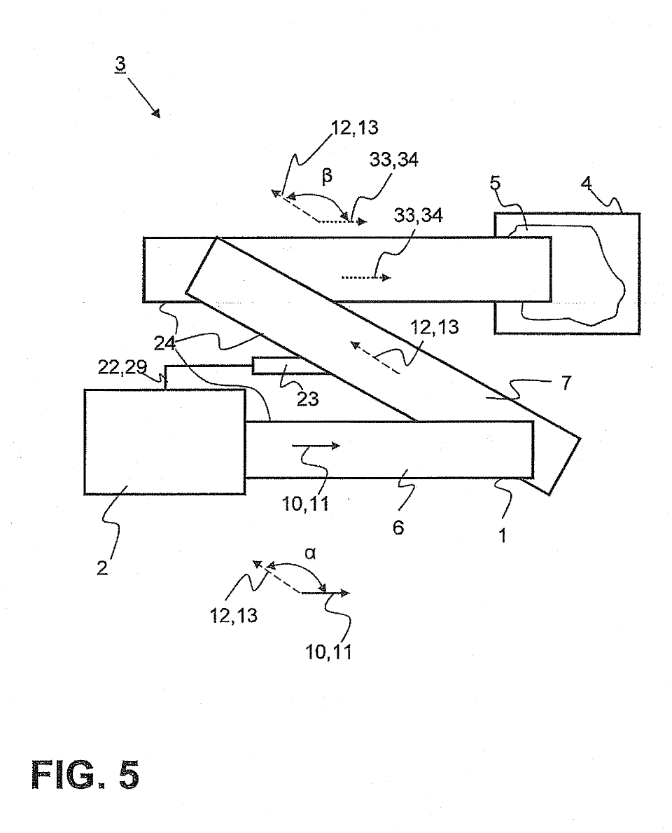

FIG. 5 a top view of a fourth embodiment of a plant according to the invention.

FIG. 1 illustrates a first preferred embodiment of an apparatus 1 according to the invention in a diagrammatic side view. The apparatus 1 is located beneath a combustion boiler 2 in which fuel, for example waste, and/or a fossil fuel, such as coal, is burnt. The apparatus 1 forms, together with the combustion boiler 2, a plant 3 which is suitable first for burning a fuel and then for transporting it away, and for collecting the material 5 in this case occurring in a container 4. The apparatus 1 shown in FIG. 1 is composed of a first conveyor belt 6 and of a second conveyor belt 7 and also a deflection device 8. The material 5 emerging on the underside (via bottom orifices) of the combustion boiler 2 passes via an outlet orifice 9 onto the first conveyor belt 6. It is routed from there in the direction of the first arrow 10 via the first conveyor belt 6 in the direction of the deflection device 8. In the apparatus 1 shown, the deflection device 8 is formed especially simply by a dropshaft. After the material on the conveyor belt 6 has first been conveyed with a first horizontal direction component 11, it is then conveyed on the second conveyor belt 7 in the direction of the second arrow 12 with a second horizontal direction component 13. While the first horizontal direction component 11 in FIG. 1 points to the right both in the horizontal portion of the conveyor belt 1 and in the inclined portion, the second horizontal direction component 13 in this figure is directed to the left (that is to say, opposite and at an angle of 180°. In the deflection device 8, the material 5 is additionally also conveyed with a vertical direction component 14 according to the third arrow 15.

The sum of the conveying lengths of the first conveyor belt 6 and of a second conveyor belt 7 and of the drop height in the deflection device 8 gives a conveying path length. Conveyance along this conveying path length may take place by means of a single conveyor belt or a plurality of separate conveyor belts. In the exemplary embodiment shown in FIG. 1, conveyance of the material 5 over the conveying path length is implemented by means of three conveyances. The first conveyance 16 takes place by means of the first conveyor belt 6. The second conveyance 17 takes place by means of a second conveyor belt 7. Finally, the third conveyance 18 forms the conveyance, taking place with a vertical direction component 14, within the deflection device 8. During the conveyance of the material 5 along the conveying path length from the outlet orifice 9 to the inlet orifice 19 in the housing, air, which flows in the direction of the fourth dashed and dotted arrows 20 from the inlet orifice 19 in the direction of the combustion boiler 2, flows over this material. In this case, the fresh air ensures sufficient oxygen for carrying out post combustion of the remaining fuel present in the material 5. On the other hand, the energy discharged by the material 5 is utilized in order to preheat the air sucked in on account of the vacuum in the combustion boiler 2, before it flows into the latter.

For monitoring the apparatus 1, a measuring device 21 is provided which is connected to a control device 23 via a measuring line 22. In the simple embodiment shown, the measuring device 21 is constructed as a temperature sensor which is located near the outlet orifice 9. By means of the control device 23 shown, the temperature near the outlet orifice 9 can be monitored, in order to avoid a situation where excessively high temperatures occur inside a housing 24 and would damage the conveyor belts 6, 7. If, for example, excessively high temperatures occur, cool outside air can be introduced in a directed way via a cooling device 25 in the direction of the fifth arrows 26 into the housing 24 in order to cool the conveyor belts 6, 7 located therein. For this purpose, cooling air inlets 27, which can be actuated individually or jointly, are provided.

By the material 5 being transported away, as illustrated in FIG. 1, at at least two heights lying one above the other in a vertical direction, it is possible to provide an apparatus 1 or plant 3 which has especially small spatial dimensions. However, despite the small dimensions, a sufficiently long conveying path length can be provided at the same time, in order to ensure cooling of the material 5 and sufficient heating of the air quantities flowing in. In this exemplary embodiment, the conveyor belts 6, 7 arranged at least partially in a vertical direction are provided with direction components which are directed exactly opposite to one another and which therefore have an angle of 180°. Alternatively, however, the advantages specified here can also be achieved with other angular arrangements lying between 90° and 180° (if an overlap of the individual conveyances in the central region is provided). It is in this case particularly advantageous if the angle becomes greater than 135°, since this then results in significant overlaps.

FIG. 2 illustrates a further embodiment of a plant. The plant 3 shown there again has a combustion boiler 2 under which the apparatus 1 is located. In addition to the first conveyor belt 6 and the second conveyor belt 7, this apparatus 1 additionally has a third conveyor belt 28. The overall conveying path length is thereby further prolonged. In this plant, the cooling air inlets 27 are connected via a second line 29 to the control device 23, so that the latter can cause the cooling air inlets 27 to open or close, as required. Furthermore, the control device 23 is connected via measuring lines 22 to further measuring devices 21 which are located in the region of the second conveyor belt 7 and of the third conveyor belt 28. In addition to temperature, these measuring devices can also detect parameters, such as, for example, the relative atmospheric moisture or the content of carbon monoxide, carbon dioxide and oxygen. The measuring devices 21 may in this case be arranged, for example, in the region of the inlet orifice 19 or of the outlet orifice or along the conveying path length. Furthermore, the apparatus 1 shown in FIG. 2 has a second deflection device 30 at which the material 5 is transferred from the second conveyor belt 7 onto the third conveyor belt 28.

Additionally, in this plant 3, a comminuting device 31 is also provided in the region of the first deflection device 8 and is composed of two contradirectionally moved rollers (here, where appropriate, a back roller or any other crusher can also operate). The comminuting device 31 can, if required, for example in the case of a decreasing air stream, be put into operation by the control device 23 via a control line 29 or be put out of operation by this. In this plant 3, too, the advantage of the especially small overall size, at the same time with a very long conveying path length for transporting away the material 5, is implemented. This advantage is achieved in that the conveyances 16, 17, 35 are located one above the other, and, as seen in a vertical direction, these have an overlap of at least 30%, but preferably of at least 50 to 70%, of the area of the conveyor belt which is projected into the horizontal.

FIG. 3 illustrates a third variant of a plant in which, once again, the overall apparatus 1 is located beneath the combustion boiler 2. The apparatus 1 shown here has a first conveyor belt 6, a second conveyor belt 7 and a third conveyor belt 28 and also the first deflection device 8 and the second deflection device 30. In this plant 3, the deflection device 8 is configured such that it can selectively deflect the material 5 onto the second conveyor belt 7 or direct it onto the third conveyor belt 28. For this purpose, moveable deflection means 32 are provided, which can be connected selectively into the position shown by the unbroken line or into the position illustrated by dashes. Preferably, the position of the deflection means 32 is determined and caused via the control device 23. For this purpose, the deflection means 32 may, for example, be motor-driven, the motors, preferably constructed as electric motors, being connected by control technology to the control device 23 via the control line 29. If in this case, for example, an especially low temperature of the material 5 is measured in the region of the outlet orifice 9 via the measuring device 21, the material 5, while it is running through the deflection device 8, can be deflected directly onto the third conveyor belt 28, since there is no longer any need for subsequent high cooling. Conversely, in the case of very high temperatures, the conveying path length of the material 5 can be prolonged considerably by the addition of the second conveyor belt 7 and of the second deflection device 30, in order thereby to achieve markedly better cooling of the material 5.

In addition, independently thereof, the cooling device 25 can also be activated, and in this case the latter, in addition to delivering air, may also include the introduction of water or steam for cooling purposes.

FIG. 4 illustrates a top view of the plant 3 according to FIG. 1. The housing 24 of the apparatus 1 can be seen beneath the combustion boiler 2. The first arrow 10 shown by a solid line in this case indicates the first horizontal direction component 11, while the second arrow 12, illustrated by dots, indicates the second horizontal direction component 13. Located on the left is the container 4 with the material 5 which is collected therein and is discharged therefrom by the second conveyor belt 7.

The two arrows 10 and 12 are illustrated once again directly adjacent to one another in the lower part of FIG. 4. It can be seen clearly there that the two arrows 10 and 12 span an angle cc which amounts to 180°. It is important in this case that the two successive horizontal direction components are to be considered. Vertical conveyance carried out, where appropriate, between them does not have to be taken into account as long as it does not comprise any appreciable horizontal direction component (for example, over an extent greater than approximately 1 m). In this embodiment according to FIG. 4, it can also be seen clearly that the first conveyor belt 6 overlaps virtually 100%, as seen in the vertical direction, the second conveyor belt 7 which lies beneath it. It must in this case basically be understood that, the greater the degree of overlap is, the smaller is the horizontal construction space requirement of the plant 3.

In the embodiment of the plant 3 according to FIG. 5, the material 5 is transported away from the combustion boiler 2 via a first conveyor belt 6, a second conveyor belt 7 and a third conveyor belt 28 to the container 4. The angles α and β are spanned between the horizontal direction components 11, 13 and 13, 34. In the embodiments shown, the two angles α and β amount to approximately 135°. It can also be seen, once again, in the top view that, in spite of the long conveying path length, the plant 3 has only a relatively small base area requirement which, moreover, decreases with increasing angles α or β. In this embodiment, moreover, degrees of overlap of 10 to 20% between the housing portions of the conveyor belts 6, 7 and 28 are implemented in the vertical direction and are considered as lower limits.

The present invention is moreover not restricted to the exemplary embodiments illustrated. Instead, numerous modifications of the invention are possible within the scope of the patent claims.

### LIST OF REFERENCE SYMBOLS

### 1 Apparatus

2 Combustion boiler

### 3 Plant

### 4 Container

### 5 Materials

6 First conveyor belt
7 Second conveyor belt
8 Deflection device
9 Outlet orifice
10 First arrow
11 First horizontal direction component
12 Second arrow
13 Second horizontal direction component
14 Vertical direction component
15 Third arrow
16 First conveyance
17 Second conveyance
18 Third conveyance
19 Inlet orifice
20 Fourth arrow
21 Measuring device
22 Measuring line
23 Control device

### 24 Housing

25 Cooling device
26 Fifth arrow
27 Cooling air inlet
28 Third conveyor belt
29 Control line
30 Second deflection device
31 Comminuting device
32 Deflection means
33 Sixth arrow
34 Third horizontal direction component
35 Fourth conveyance

1. An apparatus for the conveyance of material out of a combustion boiler, which apparatus comprises
at least one housing,
at least one conveyor belt, and
at least one deflection device,
wherein the at least one conveyor belt first conveys the material with a first horizontal direction component and, after running through the deflection device, conveys said material with at least one second horizontal direction component deviating therefrom, and
wherein the material with the first direction component constantly is separated from the material with the second direction component outside the deflection device through the housing, and the first direction component and second direction component span an angle of 135° to 180°.

2. The apparatus according to claim 1, wherein the at least one conveyor belt is arranged in an overlapping manner in a central region of a direction component.

3. The apparatus according to claim 1, wherein a third conveyance takes place in a vertical direction at least between the first conveyance with the first horizontal direction component and the second conveyance with the second horizontal direction component.

4. The apparatus according to claim 1, wherein at least one additional cooling device is provided.

5. The apparatus according to claim 1, wherein a comminuting device is provided along a conveying path formed by the at least one conveyor belt and the at least one deflection device.

6. The apparatus according to claim 1, wherein the deflection device is constructed for varying a conveying path length.

7. A plant, comprising:
a combustion boiler, and
an apparatus which is arranged beneath the combustion boiler, the apparatus including a housing, a conveyor belt and a deflection device, the apparatus being constructed to first convey material with a first horizontal direction component and, after running the material through the deflection device, convey the material with a second horizontal direction component deviating therefrom,
wherein the material with the first direction component constantly is separated from the material with the second direction component outside the deflection device through the housing, and the first direction component and second direction component span an angle of 135° to 180°.

8. The plant according to claim 7, wherein at least one measuring device is provided on the housing or therein.

9. The plant according to claim 8, wherein a control device is provided, which is connected by control technology at least to the measuring device or to the deflection device.

10. A method for transporting material away from a combustion boiler, comprising:
a) generating hot material by the combustion of a fuel in the combustion boiler;
b) conveying the material with a first horizontal direction component by means of a conveyor belt;
c) deflecting the material by means of a deflection device;
d) conveying the material with a second horizontal direction component by means of a further conveyor belt, wherein the material according to step b) is kept separate from the material according to step d), and the first and second horizontal direction components span an angle of 135° to 180°.

11. The method according to claim 10, wherein the number of deflections by means of the deflection device is determined and executed as a function of at least one measured variable.
